(19) United States
(12) Patent Application Publication
(10) Pub. No.: US 2013/0290487 A1
(43) Pub. Date: Oct. 31, 2013

(54) METHOD FOR TRANSFERRING MULTIMEDIA DATA OVER A NETWORK

(71) Applicants: Vincent Hiribarren, Nozay (FR); Patrick Legrand, Nozay (FR)

(72) Inventors: Vincent Hiribarren, Nozay (FR); Patrick Legrand, Nozay (FR)

(73) Assignee: ALCATEL LUCENT, Paris (FR)

(21) Appl. No.: 13/992,010

(22) PCT Filed: Dec. 2, 2011
(86) PCT No.: PCT/EP2011/071655

§ 371 Date: Jun. 6, 2013

(30) Foreign Application Priority Data
Dec. 7, 2010 (FR) 1004771

(51) Int. Cl. H04L 29/06

(52) U.S. Cl. CPC H04L 65/60
USPC 709/217

(57) ABSTRACT

The invention pertains to a method for transferring multimedia data (9) over a network (1) comprising several terminals (3, 5, 7) linked to at least one storage device (11), consisting of the following steps: One selects a source terminal (5) playing multimedia content by using a mobile interface terminal (3), One selects a sequence of multimedia content being played from among the available multimedia content, One identifies a target terminal (7), One assesses the compatibility of the data (9) with the selected target terminal (7), Where applicable, one transfers the selected data (9), or the data converted from the selected data (9), to the target terminal (7) through the network (1).

The invention pertains to a method for transferring multimedia data over a network, from a source multimedia terminal to a target multimedia terminal.

The number of multimedia terminals on subscriber premises networks is continuously growing. In fact, an individual's Internet router is linked to terminals such as televisions, stereo systems, digital screens or photo frames, mobile telephones equipped with an Internet connection and one or more computers.

Typically, all of these terminals are heterogeneous, and sometimes process different types of data: videos, audio streams, images, slide shows, or text. However, these data may be compatible with several terminals in the subscriber premises network.

By default, to transfer data from one terminal to another that uses the same type of data, the user must use a computer and a transfer medium such as a CD, DVD or an EEPROM flash storage device.

Additionally, various types of data may be related. For example, a video clip, a song, and the cover image from the album from which it was excerpted may be considered to be related. To transfer data related to those stored or in use on one terminal to another terminal, the user must use a computer and a means of transfer. The user must then manually search for the data on the network and/or on the Internet using a search engine, and then carry out screen captures or downloads.

For example, if the user wants to use his or her stereo system to listen to the music from a video that he or she is watching on television, he or she must manually search for the song, transfer it to the stereo system and then play it.

Managing media on the network therefore requires a certain mastery of computer tools as well as some relatively protracted manual operations.

To make up for at least some of the aforementioned problems, the invention proposes a method for transferring multimedia data over a network containing several terminals, consisting of the following steps:
One selects a source terminal playing multimedia content by using a mobile interface terminal,
One selects a sequence of multimedia content being played from among available multimedia content,
One identifies a target terminal,
One assesses the compatibility of the data with the selected target terminal,
Where applicable, one transfers the data identified, or the data converted from data identified, to the target terminal through the network.

The method for transferring data between heterogeneous terminals has been simplified, the user therefore has a system that is simple and ergonomic to use.

The method may also include one or more of the following characteristics, taken separately or in combination.

The interface terminal is a personal digital assistant.

The interface terminal is a smartphone.

the interface terminal is an electronic tablet.

The source and/or target terminals are components from the following list:

television, stereo system, digital photo frame, computer, personal digital assistant, smart phone, or electronic tablet.

The data transferred are one or more of the components of the following list:

text, image, screen capture, slide show, video sequence, or audio sequence.

The method comprises the following steps:
The available terminals emit at least one electromagnetic signal, such as a radio frequency identification signal, a Wi-Fi signal, or a Bluetooth signal, comprising an identifier,
The interface terminal receives at least one electromagnetic signal and identifies the available terminal or terminals,
One selects the broadcast terminal and/or the target terminal from among the identified terminals.

The source and/or target terminals are selected by photographic reading of at least one optical code associated with the source and/or target terminals.

The method comprises the following steps:
One positions the interface terminal with at least one network terminal
One establishes a list of network terminals near the interface terminal,
One selects the source and/or target terminals from the established list.

If the selected data are incompatible with the target terminal, one carries out a search for related data on the network to be transferred to the target terminal in place of the selected data.

If it is impossible to copy the data to an intermediate storage device, one redirects the multimedia data flow corresponding to the selected data to the target terminal for broadcast.

One searches for any potential restrictions on the use of the data before saving them.

The method also comprises a step in which the broadcast terminal and/or the target terminal authenticate the interface terminal.

Other characteristics and advantages shall become apparent upon reading the description of the following images, presented as non-limitative examples, in which:

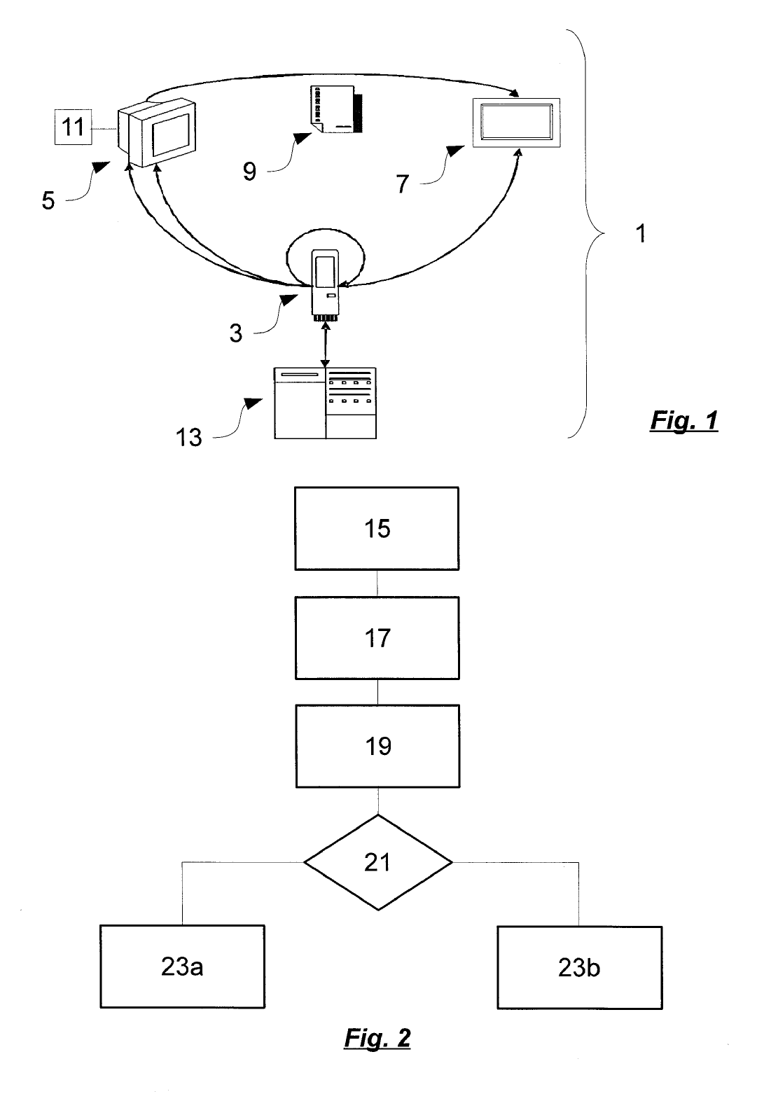

FIG. 1 schematically depicts the terminals involved in the method and the main steps for an embodiment of said method;

FIG. 2 is a flow diagram showing the steps of a first embodiment of the method;

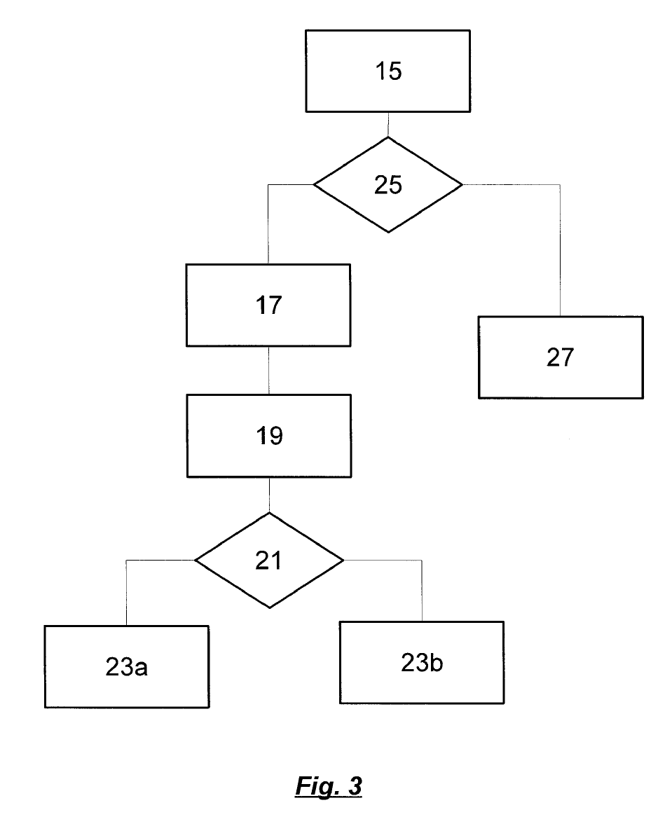

FIG. 3 is a flow diagram showing the steps of a second embodiment of the method.

On all figures, the same references refer to the same components.

The invention pertains to a method for transferring data over a network. FIG. 1 schematically shows a subscriber premises network according to the invention. Network 1 comprises several terminals 3, 5, and 7. Interface terminal 3 is designed to allow the user to interact with the network terminals. Source terminal 5 is broadcasting multimedia content that includes the data 9, part of which the user wishes to transfer. The last terminal is the target terminal 7, toward which the user wishes to transfer the data 9. To enable the data transfer, the source 5 and target 7 terminals are linked to at least one storage device, configured to allow the data 9 corresponding to the content sequence to be recorded. FIG. 1 only shows storage device 11 linked to the source terminal.

In the example in FIG. 1, interface terminal 3 is a smartphone. As said interface terminal 3 is designed to allow the user to interact with the other terminals 5, and 7 on network 1, it should preferably be mobile and easy for the user to transport. Therefore, interface terminal 3 may also be a personal digital assistant, an electronic tablet, or portable computer.

The source 5 and target 7 terminals are multimedia content broadcast terminals, such as televisions, stereo systems, digital photo frames, computers, personal digital assistants, or smartphones, or any other terminal able to broadcast multimedia content. In the example shown in FIG. 1, source terminal 5 is shown as a television, and target terminal 7 as a digital photo frame.

Therefore, the data 9 corresponding to the content sequence that the user wishes to transfer may be text, an image, especially a screen capture, a slide show, a video or audio sequence, or any other media type.

The user wishes to transfer the image currently displayed on television 5 from said television 5 to digital photo frame 7. To do this, he or she will first select television 5 currently broadcasting a video flow by using his or her mobile telephone 3. Then, he or she will select a screen capture, still using his or her mobile telephone 3, which will be stored in the form of the data 9 in image format on storage device 11, linked to source terminal 5. Then the user will select the photo frame 7. Network 1 will then transfer the data 9 corresponding to the selected screen capture from storage device 11 on television 5 to photo frame 7, and potentially convert the data 9 so that the image can be displayed by photo frame 7.

For an IP network, terminals 3, 5, and 7 are configured to communicate with server 13. Server 13 ensures communication between the terminals 3, 5, and 7 on the network by applying an address resolution protocol.

For this purpose, as an example, interface terminal 3 will save identifiers, addresses, and any potential authentication data (code, password) for source terminal 5 when it is selected, and/or those for target terminal 7 when it is selected as well. Mobile interface terminal 3 will then transmit the data mentioned above to the components of network 1 in order to establish a connection between source terminal 5 and target terminal 7.

For example, after interface terminal 3 has collected the identifiers for source terminal 5 and target terminal 7 upon their selection, it can transmit said identifiers to server 13, which is configured to apply an address resolution protocol. Then server 13 will use the identifiers to deduce the addresses of the source 5 and target 7 terminals by address resolution, and then establish a connection between them and initiate the transfer of multimedia data 9.

Alternatively, interface terminal 3 may transmit the identifiers, addresses, and authentication data for either the source 5 or target 7 terminal to the other, respectively the target 7 or source 5 terminal. The source 5 or target 7 terminal receiving the aforementioned data are equipped with login “bootstrapping” and therefore directly establish a connection between the two terminals 5 and 7 without passing through central server 13.

Interface terminal 3 may also store a list of the data types and formats accepted by all components on network 1, as well as their abilities to convert from one format to another so as to be able to manage any potential automatic conversion of data 9 by at least one third terminal interposed between source terminal 5 and target 7 on the path of data 9.

In general, interface terminal 3 may calculate a path for data 9 passing through a certain number of terminals configured to convert data 9 depending upon their abilities so that the succession of conversions produces a data type and format suitable for reading by target terminal 7 when these data arrive at target terminal 7.

If the selected multimedia data 9 are in the form of a stream that cannot be copied to an intermediate storage device 11, which is the case for example with a radio or television programme, interface terminal 3 may potentially redirect the data flow from source terminal 5 to target terminal 7 through server 13, so that the data flow corresponding to the selected data 9 are broadcast by target terminal 7 instead of source terminal 5.

FIG. 2 shows the various steps of the interaction between these components allowing the method to be executed.

The first step 15 is the use of the mobile interface terminal such as source terminal 5 to select a terminal broadcasting multimedia content on network 1. For example, interface terminal 3 may detect short-range electromagnetic signals such as Bluetooth™ signals, short wave radio frequencies, or infrared waves emitted by the various available terminals. The signals contain an identifier for the terminal emitting them. The user can then select one of these terminals from a list.

The identifier may also be encoded into a passive RFID chip. The RFID chip is read by passing interface terminal 3 within a few centimetres of the desired terminal, so that a connection can be made between the emitter interface terminal 3 and the RFID chip that returns a signal in response to excitation from the signal emitted from interface terminal 3.

The limited range of the signals will ensure that source terminal 5 and target terminal 7 are close and located, in particular, within the same space, such as the user's home or in the same room of said home. If the selection is made from a pre-established list of terminals on network 1, said terminals may be divided into groups corresponding to predefined spaces, such as a specific room within the user's home in which network 1 is located. After selecting a source terminal 5, the user then selects the target terminal 7 from among the terminals in the same group on the list so as to simplify and accelerate the transfer method.

Then, in the second step 17, the user selects a sequence of multimedia content to be transferred from among the multimedia content being played. In the example in FIG. 1, the user selects an image, corresponding to a screen capture. Interface terminal 3 then sends a screen capture request, potentially through server 13.

During the third step 19, the data 9 corresponding to the selected content sequence are stored in storage device 11 on a component of network 1. In particular, in the example in FIG. 1, the television 5 has a storage device 11 that can be used to record video sequences and screen captures. The image corresponding to the screen capture selected by the user is then stored in said storage device 11.

However, through another embodiment, it is possible to save to a storage device linked to interface terminal 3, or to a storage device linked to server 13.

Then, in the fourth step 19, the user uses interface terminal 3 to identify a target terminal 7 that is near source terminal 5 from among the terminals on network 1. In the example in FIG. 1, the user selects from the previously established list of terminals detected by short-range electromagnetic signal. This selection may be made again from a list established by receiving the electromagnetic signals emitted from the available terminals.

In the fifth step 21, interface terminal 3 assesses the compatibility of the data 9 with the selected target terminal 7. If the data 9 and terminal 7 are compatible, the data 9 are transferred to target terminal 7 during step 23a. If the data 9 and target terminal 7 are incompatible, the data 9 are converted by a component on network 1 with the conversion resources, and the converted data are then transferred to target terminal 7 in step 23b.

Conversion 23b of data 9 may be performed by interface terminal 3, source terminal 5, or target terminal 7, if at least one of them has suitable conversion resources. Alternatively, interface terminal 3 or server 13 may be configured to search network 1 for a terminal able to carry out the conversion; the data 9 will then be transferred to that terminal which will carry out conversion 23b.

The method may also include at least one step by which either server 13 or one of the other terminals 3, 5, or 7 authenticate one of the terminals 3, 5, or 7. Therefore, access to certain terminals may be restricted to control access to their content.

For example, on a network located in a public area, a terminal may be configured so that only the terminals having an encrypted identifier may use the given terminal such as target terminal 7, while no identifier is required to use a terminal such as source terminal 5. Said terminal is then a terminal intended to serve as source terminal 5, whose content is freely accessible.

If interface terminal 3 comprises an Internet site or resources for searching a database, it may be configured to find potential keywords among the data 9 to be transferred. Then, interface terminal 3 can propose to substitute conversion step 23b for data 9 that are incompatible with target terminal 7 with a search step for related data in a format compatible with target terminal 7, found on the Internet and/or in the database through a search engine.

An alternative embodiment allows the use of an optical sensor linked to interface terminal 3 to select source terminal 5 and/or target terminal 7. In particular, the optical sensor may include an integrated camera when the interface terminal is a smartphone.

For example, terminals 5, and 7 on network 1 may contain an optical code such as a bar code, and interface terminal 3 is configured to detect and read said optical code and link it to the selection of terminal 5 or 7 to which it corresponds.

In particular, the optical code may be a Bokode type optical code, which is to say a two-dimensional bar code whose content is read using an optical device focused beyond or short of the physical medium of said code, typically optical infinity, and which may be read at a distance of a few meters. It may also be a QR code, a two-dimensional bar code that one scans by taking its photo, and which can be read at a distance of approximately one metre.

Another alternative embodiment allows for the selection of source and target terminals 5 and 7 to include a step for the location of interface terminal 3 in relation to the components on network 1. For example, the interface terminal may be located by triangulation in relation to short range antennae, or each room of the building in which the network is located may be equipped with an antenna detecting interface terminal 3 when it is in the given room.

If network 1 covers a broad area, one can find the position of the interface terminal using a positioning device such as a GPS, and the coordinates of said interface terminal 3 are sent to server 13.

Server 11 compares the position communicated by the interface terminal with the position of the various terminals on network 1. Server 11 can then send a list comprising either the terminals located within a predetermined radius around the position of interface terminal 3, or a group of network terminals distributed across a defined space around the established position of interface terminal 3; for example the network 1 terminals located in the same room as interface terminal 3.

FIG. 3 shows an alternative embodiment of the method, in which the method also comprises a step 25 that searches for usage restrictions on the data 9, before step 17 of saving the data 9 to storage device 11 linked to terminal 5. During this step 27, interface terminal 3 searches to find out whether the selected data 9 are protected by copyright, or if they are part of the public domain. If the data 9 that the user wishes to transfer are protected, the interface terminal will prohibit copying of the data 9 to the storage device in step 27 and alert the user to the presence of said usage restrictions.

The transfer method simplifies the use of multimedia terminals over a network, and, in particular, it simplifies transfers between terminals on the network.

1. Method for transferring multimedia data over a network, comprising several terminals, the method comprising:
One selects a source terminal playing multimedia content by using a mobile interface terminal,
One uses a mobile interface terminal to select a sequence of multimedia content being played from among the available multimedia content,
One identifies a target terminal, using the mobile interface terminal,
One assesses the compatibility of the data with the selected target terminal,
Where applicable, one transfers the data identified, or the data converted from data identified (9), to the target terminal through the network.

2. Method according to claim 1, in which the interface terminal is a personal digital assistant.

3. Method according to claim 1, in which the interface terminal is a smartphone.

4. Method according to claim 1, in which the interface terminal is an electronic tablet.

5. Method according to claim 1 in which the source terminal and/or the target terminal are components from the following list:
television, stereo system, digital photo frame, computer, personal digital assistant, smartphone, or electronic tablet.

6. Method according to claim 1 in which the data transferred are one or more components from the following list: text, image, screen capture, slide show, video sequence, audio sequence.

7. Method according to claim 1 in which:
The terminals available emit at least one electromagnetic signal, such as a radio frequency identification signal, a Wi-Fi signal, or a Bluetooth signal, comprising an identifier,
The interface terminal receives at least one electromagnetic signal and identifies the available terminal or terminals,
One selects the source terminal and/or the target terminal from among the identified terminals.

8. Method according to claim 1 in which one selects the source terminal and/or the target terminal by photographic reading of at least one optical code linked to the source terminal and/or the target terminal.

9. Method according to claim 1 in which:
One positions the interface terminal with at least one network terminal,
One establishes a list of network terminals near the interface terminal,
One selects the source and/or target terminals from the established list.

10. Method according to claim 1 in which if the selected data are incompatible with the target terminal one carries out a search for related data on the network to be transferred to the target terminal in place of the selected data.

11. Method according to claim 1 in which if it is impossible to copy the data to an intermediate storage device, one redirects the multimedia data flow corresponding to the selected data to the target terminal so that it can broadcast them.

12. Method according to claim 1 in which one searches for any potential usage restrictions on the data before saving them.

13. Method according to claim 1 additionally comprising the broadcasting terminal and/or the target terminal authenticate the interface terminal.
